(19) United States
(12) Patent Application Publication
(10) Pub. No.: US 2021/0132384 A1
(43) Pub. Date: May 6, 2021

(54) Tilted In-Field Light Sources

(71) Applicant: Facebook Technologies, LLC, Menlo Park, CA (US)

(72) Inventors: Christopher Yuan-Ting Liao, Seattle, WA (US); Qi Zhang, Kirkland, WA (US); Kurt Allen Jenkins, Sammamish, WA (US); Karol Constantine Hatzilias, Kenmore, WA (US); Robin Sharma, Redmond, WA (US); Alexander Sohn, Seattle, WA (US); Silvio Grespan, Santa Clara, CA (US); Gangok Lee, Bothell, WA (US)

(21) Appl. No.: 16/825,554

(22) Filed: Mar. 20, 2020

Related U.S. Application Data
(60) Provisional application No. 62/931,433, filed on Nov. 6, 2019.

(51) Int. Cl. G02B 27/01

(52) U.S. Cl. CPC G02B 27/0172; G02B 2027/0123; G02B 2027/0178; G02B 27/0101

(57) ABSTRACT

A near-eye optical element includes light sources arranged with an illumination layer. The light sources are angled to direct light from the light sources to illuminate an ocular region.

### CROSS-REFERENCE TO RELATED APPLICATIONS

This application claims priority to U.S. provisional Application No. 62/931,433 filed Nov. 6, 2019, which is hereby incorporated by reference.

### BACKGROUND INFORMATION

There are a variety of application where light sources such as vertical-cavity surface-emitting lasers (VCSELs) and LEDs are utilized as light sources. In some applications, it may be desirable to direct the beam emitted from the light source in a particular direction. In one particular context, light sources may be utilized to illuminate a subject for purposes of imaging the subject.

### BRIEF DESCRIPTION OF THE DRAWINGS

Non-limiting and non-exhaustive implementations of the invention are described with reference to the following figures, wherein like reference numerals refer to like parts throughout the various views unless otherwise specified.

FIG. 1 illustrates an example HMD 100, in accordance with aspects of the disclosure.

FIG. 2 is a top view of an example near-eye optical element that includes an illumination layer, in accordance with aspects of the disclosure.

FIG. 3 illustrates a cross-section of an example illumination layer, in accordance with aspects of the disclosure.

FIG. 4 illustrates a cross-section of an example illumination layer that includes an illumination film layer, in accordance with aspects of the disclosure.

FIG. 5 illustrates a cross-section of an example illumination layer, in accordance with aspects of the disclosure.

FIG. 6 illustrates a cross-section of an example illumination layer, in accordance with aspects of the disclosure.

FIGS. 7A-7C illustrate portions of an example illumination layer fabrication technique, in accordance with aspects of the disclosure.

FIGS. 8A-8C illustrate a fabrication technique for an illumination layer having an illumination film layer, in accordance with aspects of the disclosure.

FIGS. 9A-9F illustrate an example fabrication process for an illumination layer, in accordance with aspects of the disclosure.

### DETAILED DESCRIPTION

Embodiments of tilted in-field light sources are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one implementation” or “an implementation” means that a particular feature, structure, or characteristic described in connection with the implementation is included in at least one implementation of the present invention. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

Embodiments of the disclosure include in-field light sources being integrated into a near-eye lens where the in-field light sources are tilted to illuminate an ocular region. The in-field light sources (e.g. LEDs or lasers) may be encapsulated within a transparent optical material in a near-eye optical element. The in-field light sources may be disposed over predefined tilted platform that are angled to direct the plurality of light sources to illuminate the ocular region with non-visible (e.g. near-infrared) light. In some implementations, an illumination film layer including electrical traces for providing power to the in-field light sources is disposed over the predefined tilted platforms. Encapsulating in-field light sources over predefined tilted platforms may allow designers to control the pattern and shape of the non-visible illumination light illuminating an ocular region without adding additional beam shaping components (e.g. micro lenses) to the in-field light sources. Designing the pattern and shape of non-visible illumination light may improve tracking eye-positions, for example.

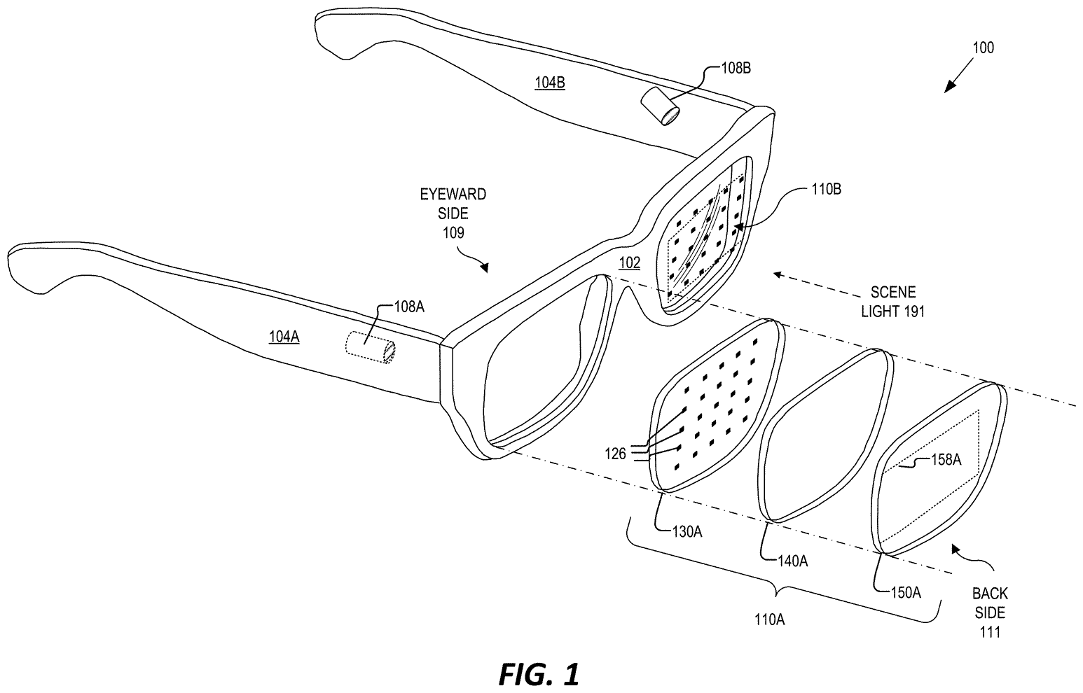

In an example fabrication technique for a near-eye optical element, an illumination film layer that includes non-visible light sources is positioned over a mechanical fixture configured to define tilted platforms angled to direct the non-visible light sources to illuminate the ocular region. A transparent optical resin is than disposed over the illumination film layer while the illumination film layer (and the non-visible light sources) are disposed over the tilted platforms. After the transparent optical resin cures and the mechanical fixture is removed, a second optical resin may then be over-molded on to a backside of the illumination film layer. In this way, a near-eye optical element may be fabricated having non-visible light sources encapsulated in a transparent material where the non-visible light sources are positioned at a designed angle to illuminate an ocular region with non-visible light (e.g. near infrared light). These and other implementations are described in more detail in connection with FIGS. 1-9F.

FIG. 1 illustrates an example HMD 100, in accordance with aspects of the present disclosure. The illustrated example of HMD 100 is shown as including a frame 102, temple arms 104A and 104B, and near-eye optical elements 110A and 110B. Eye-tracking cameras 108A and 108B are shown as coupled to temple arms 104A and 104B, respectively. FIG. 1 also illustrates an exploded view of an example of near-eye optical element 110A. Near-eye optical element 110A is shown as including an illumination layer 130A, an optical combiner layer 140A, and a display layer 150A. Illumination layer 130A is shown as including a plurality of in-field light sources 126. The in-field light source 126 may be configured to emit non-visible light (e.g. infrared illumination light) for eye-tracking purposes, for example. Display layer 150A may include a waveguide 158 that is configured to direct virtual images to an eye of a user of HMD 100.

As shown in FIG. 1, frame 102 is coupled to temple arms 104A and 104B for securing the HMD 100 to the head of a user. Example HMD 100 may also include supporting hardware incorporated into the frame 102 and/or temple arms 104A and 104B. The hardware of HMD 100 may include any of processing logic, wired and/or wireless data interface for sending and receiving data, graphic processors, and one or more memories for storing data and computer-executable instructions. In one example, HMD 100 may be configured to receive wired power and/or may be configured to be powered by one or more batteries. In addition, HMD 100 may be configured to receive wired and/or wireless data including video data.

FIG. 1 illustrates near-eye optical elements 110A and 110B that are configured to be mounted to the frame 102. In some examples, near-eye optical elements 110A and 110B may appear transparent to the user to facilitate augmented reality or mixed reality such that the user can view visible scene light from the environment while also receiving display light directed to their eye(s) by way of display layer 150A. In further examples, some or all of near-eye optical elements 110A and 110B may be incorporated into a virtual reality headset where the transparent nature of the near-eye optical elements 110A and 110B allows the user to view an electronic display (e.g., a liquid crystal display (LCD), an organic light emitting diode (OLED) display, a micro-LED display, etc.) incorporated in the virtual reality headset.

As shown in FIG. 1, illumination layer 130A includes a plurality of in-field light sources 126. Each in-field light source 126 may be disposed on a transparent substrate and may be configured to emit light towards an eyeward side 109 of the near-eye optical element 110A. In some aspects of the disclosure, the in-field light sources 126 are configured to emit near infrared light (e.g. 700 nm-1.4 μm). Each in-field light source 126 may be a micro light emitting diode (micro-LED), an edge emitting LED, a vertical cavity surface emitting laser (VCSEL) diode, or a Superluminescent diode (SLED).

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700 nm-1.4 μm. In aspects of this disclosure, near-infrared light emitted by in-field light sources is centered around 850 nm. In aspects of this disclosure, near-infrared light emitted by in-field light sources is centered around 940 nm.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

Conventional eye-tracking solutions may provide light sources disposed around a rim/periphery of a lens. However, placing light sources within the field of view of the eye may be advantageous for computation of specular or “glint” reflections that can be imaged by a camera such as eye-tracking camera 108A that is positioned to image the eye of a wearer of HMD 100.

While in-field light sources 126 may introduce minor occlusions into the near-eye optical element 110A within a field-of-view of a wearer/user, the in-field light sources 126, as well as their corresponding electrical routing may be so small as to be unnoticeable or insignificant to a wearer of HMD 100. Additionally, any occlusion from in-field light sources 126 will be placed so close to the eye as to be unfocusable by the human eye and therefore assist in the in-field light sources 126 being not noticeable or insignificant. In some implementations, each in-field light source 126 has a footprint (or size) that is less than about 200×200 microns.

As mentioned above, the in-field light sources 126 of the illumination layer 130A may be configured to emit infrared illumination light towards the eyeward side 109 of the near-eye optical element 110A to illuminate the eye of a user. The near-eye optical element 110A is shown as including optical combiner layer 140A where the optical combiner layer 140A is disposed between the illumination layer 130A and a backside 111 of the near-eye optical element 110A. In some aspects, the optical combiner 140A is configured to receive reflected infrared light that is reflected by the eye of the user and to direct the reflected infrared light towards the eye-tracking camera 108A. In some examples, the eye-tracking camera 108A is an infrared camera configured to image the eye of the user based on the received reflected infrared light. In some aspects, the optical combiner 140A is transmissive to visible light, such as scene light 191 incident on the backside 111 of the near-eye optical element 110A. In some examples, the optical combiner 140A may be configured as a volume hologram and/or may include one or more Bragg gratings for directing the reflected infrared light towards the eye-tracking camera 108A. In some examples, the optical combiner includes a polarization-selective hologram (a.k.a. polarized volume hologram) that diffracts a particular polarization orientation of incident light while passing other polarization orientations.

Display layer 150A may include one or more other optical elements depending on the design of the HMD 100. For example, the display layer 150A may include a waveguide 158 to direct display light generated by an electronic display to the eye of the user. In some implementations, at least a portion of the electronic display is included in the frame 102 of the HMD 100. The electronic display may include an LCD, an organic light emitting diode (OLED) display, micro-LED display, pico-projector, or liquid crystal on silicon (LCOS) display for generating the display light. In some embodiments, near-eye optical elements 110 may not include a display and may be included in a head mounted device that is not considered a head mounted display.

Optical combiner layer 140A is shown as being disposed between illumination layer 130A and the display layer 150A. In some examples, the illumination layer 130A has a lens curvature for focusing light (e.g., display light and/or scene light) to the eye of the user on the eyeward side 109 of the near-eye optical element 110A. Thus, the illumination layer 130A may, in some examples, may be referred to as a lens. In some aspects, the illumination layer 130A has a thickness and/or curvature that corresponds to the specifications of a user. In other words, illumination layer 130A may be a prescription lens. However, in other examples, illumination layer 130A may be a non-prescription lens.

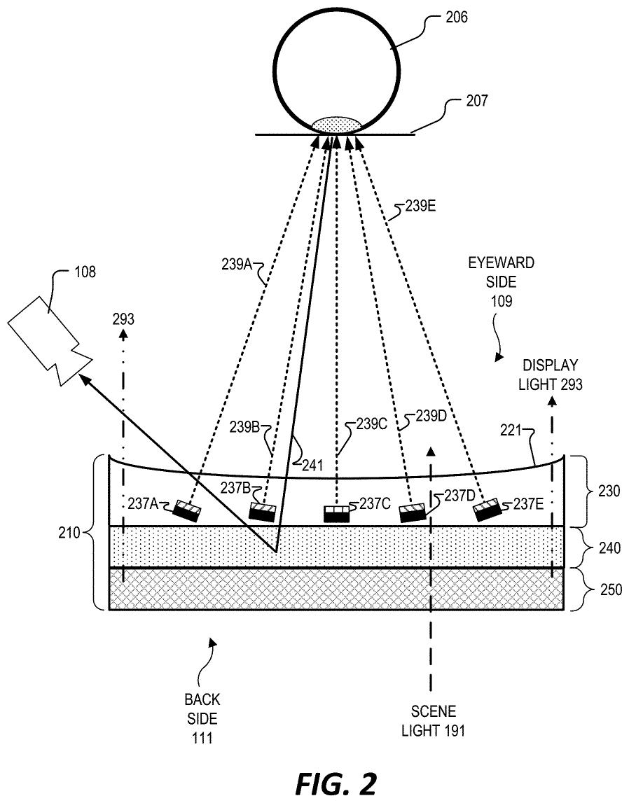

FIG. 2 is a top view of an example near-eye optical element 210 that includes an illumination layer 230, a combiner layer 240, and a display layer 250. In some implementations, display layer 250 is not included in near-eye optical element 210. Near-eye optical element 210 is an example near-eye optical element that may be used as near-eye optical element 110, for example. A plurality of light sources 237 emit non-visible illumination light to an ocular region 207 to illuminate eye 206. FIG. 2 illustrates light sources 237A-237E. The different light sources 237 may direct non-visible illumination light 239 (e.g. infrared illumination light) to eye 206 in an ocular region 207 at different angles depending on the position of the light source 237 with respect to eye 206. For example, light sources 237A and 237E may emit non-visible illumination light 239A/239E to eye 206 at steeper angles compared to light source 237C directing non-visible illumination light 239C to eye 206 at an angle closer to normal. In other words, a beam direction of a given light source 237 may be determined by a position of the particular light source with respect to the ocular region where eye 206 of a user would be positioned. The plurality of light sources 237 may be encapsulated in the transparent illumination layer at different angles to direct the plurality of light sources inward to illuminate ocular region 207. As described above, light sources 237 may be VCSELs or SLEDs, and consequently non-visible illumination light may be narrow-band infrared illumination light (e.g. linewidth of 0.1-10 nm), in some implementations.

Eye 206 reflects at least a portion of the non-visible illumination light 239 back to element 210 as reflected infrared light 241 and the reflected infrared light 241 propagates through illumination layer 230 before encountering combiner layer 240. Combiner layer 240 is configured to receive the reflected infrared light 241 and direct the reflected infrared light 241 to the camera 108 to generate eye-tracking images. Camera 108 is configured to capture eye-tracking images of eye 206. Camera 108 may include an infrared bandpass filter to pass the wavelength of the non-visible illumination light emitted by the light sources 237 and block other light from becoming incident on an image sensor of camera 108. Camera 108A may include a complementary metal-oxide semiconductor (CMOS) image sensor.

FIG. 2 shows that scene light 191 (visible light) from the external environment may propagate through display layer 250, combiner layer 240, and illumination layer 230 to become incident on eye 206 so that a user can view the scene of an external environment. FIG. 2 shows that display layer 250 may generate or redirect display light 293 to present virtual images to eye 206. Display light 293 is visible light and propagates through combiner layer 240 and illumination layer 230 to reach eye 206.

Transparent layer 220 may include a lens curvature 221 that is the surface closest to eyeward side 109. Lens curvature 221 may be configured to focus a virtual image included in display light 293 for an eye of a user or and/or to focus scene light 191 for an eye of a user. Lens curvature 221 may be spherical. Lens curvature 221 may be formed in a refractive material of illumination layer 230 using a subtractive process. Alternatively, lens curvature 221 may be formed in a refractive material of illumination layer 230 in an additive process such as three-dimensional (3D) printing or using molding or casting techniques. The refractive material may have a refractive index of approximately 1.5, in some implementations. The refractive material may encapsulate the non-visible light sources 237. The refractive material may be configured to transmit visible light and near-infrared light.

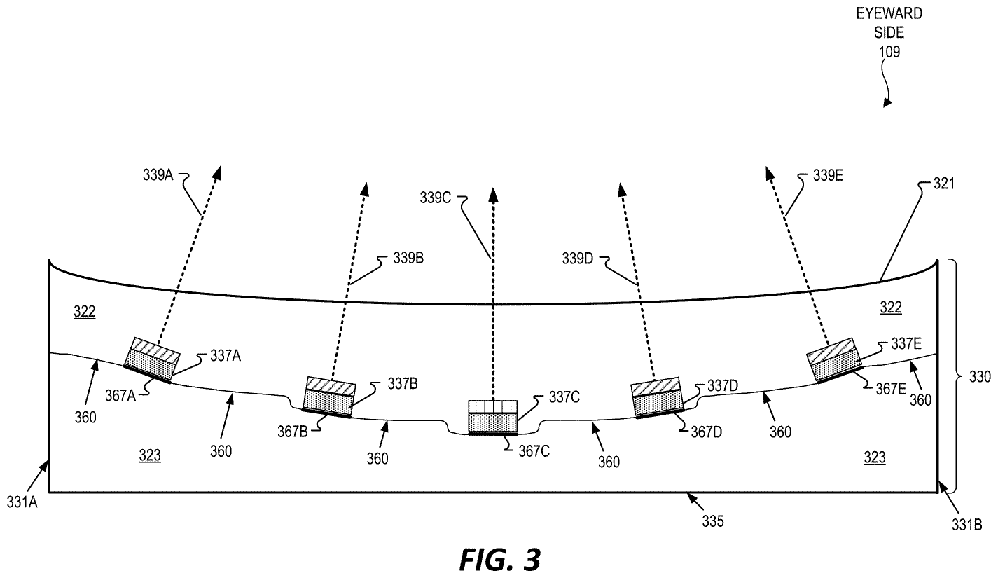

FIG. 3 illustrates a cross-section of an example illumination layer 330, in accordance with aspects of the disclosure. FIG. 3 illustrates a transparent substrate 323 that is defined by a surface shape 360 including a plurality of predefined tilted platforms 367. In FIG. 3, each predefined tilted platform 367 has a one-to-one correspondence with a corresponding non-visible light source 337. For example, light source 337A corresponds to predefined tilted platform 367A, light source 337B corresponds to predefined tilted platform 367B, light source 337C corresponds to predefined tilted platform 367C, light source 337D corresponds to predefined tilted platform 367D, and light source 337E corresponds to predefined tilted platform 367E. An increased line-weight is used in FIG. 3 to show where the predefined tilted platform is positioned, although each predefined tilted platform may just be a particular location in the surface shape 360. A transparent encapsulation layer 322 is shown as included in illumination layer 330. Transparent encapsulation layer 322 encapsulates light sources 337. A lens curvature 321 on the eyeward side 109 of the transparent encapsulation layer 322 may be formed in transparent encapsulation layer 322. Transparent encapsulation layer 322 may have a same or substantially same refractive index as transparent substrate 323.

In one implementation, surface shape 360 is rotationally symmetric about an axis in the middle of transparent substrate 323 between an outside boundary of transparent substrate 323. Outside boundaries 331A and 331B are shown at the outside boundaries of transparent substrate 323 and transparent encapsulation layer 322.

FIG. 3 shows that a tilt angle of a given predefined tilted platform 367 may increase as the given predefined tilted platform gets nearer to the outside boundary of the transparent substrate 323. For example, the tilt angle of platform 367C may be substantially zero degrees with respect to a planar boundary 335 of transparent substrate 323 while the tilt angle of platforms 367B and 367D may be approximately five degrees with respect to the planar boundary 335. The tilt angle of platform 367E may be approximately fifteen degrees with respect to planar boundary 335. Thus, the tilt angle of platform 367D may be greater than the tilt angle of platform 367C and the tilt angle of platform 367E may be greater than the tilt angle of platform 367D. Similarly, the tilt angle of platform 367A may be greater than the tilt angle of platform 367B which may be greater than the tilt angle of platform 367C.

A beam direction of illumination light 339 emitted by each light source 337 is determined by the tilt angle of the corresponding platform 367. Thus, as the tilt angle increases, the beam angle of the illumination light 339 may also increase with respect to a beam angle that is orthogonal to an eye 206. Illumination light 339C may be emitted in a beam direction that has a beam angle that is orthogonal to eye 206 whereas illumination light 339B and 339D may have an increased beam angle with respect to a beam angle that is orthogonal to eye 206. Similarly, illumination light 339A and 339E may have an increased beam angle with respect to a beam angle of illumination light 339B and 339D.

In FIG. 3, a given predefined tilted platform 367 is positioned closer to eyeward side 109 as a distance of the given predefined tilted platform 367 from the outside boundary of the transparent substrate decreases. For example, predefined tilted platform 367E is positioned closer to eyeward side 109 than predefined tilted platform 367D and the distance from outside boundary 331B to predefined tilted platform 367E is shorter than a distance from predefined tilted platform 367D to outside boundary 331B. Similarly, predefined tilted platform 367B is positioned closer to eyeward side 109 than predefined tilted platform 367C and the distance from outside boundary 331A to predefined tilted platform 367B is shorter than a distance from predefined tilted platform 367C to outside boundary 331A.

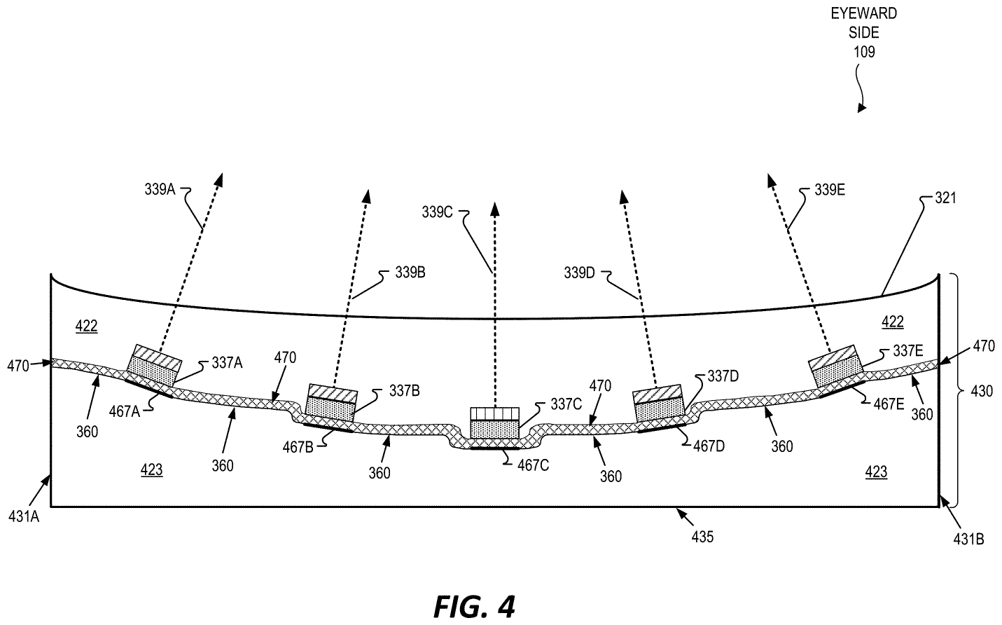

FIG. 4 illustrates a cross-section of an example illumination layer 430, in accordance with aspects of the disclosure. Illumination layer 430 includes an illumination film layer 470 disposed between transparent substrate 423 and transparent encapsulation layer 422. Surface shape 460 may be the same or substantially the same as surface shape 360 and predefined tilted platforms 467 may be the same or substantially the same as predefined tilted platforms 367. Illumination film layer 470 may be transparent or substantially transparent to visible light and near infrared light. Illumination film layer 470 may include electrical traces configured to provide electrical power to the plurality of light sources 337. The electrical nodes (e.g. anode node and cathode node) of light sources 337 are bonded to the electrical traces of illumination film layer 470. The electrical traces may be made from a transparent or semi-transparent oxide that is a conductor or semiconductor. In one implementation, the electrical traces include indium tin oxide (ITO). The electrical traces may be copper, gold, or other conducting metal. In FIG. 4, illumination film layer 470 is layered over transparent substrate 423.

In FIG. 4, each predefined tilted platform has a one-to-one correspondence with a corresponding non-visible light source 337. For example, light source 337A corresponds to predefined tilted platform 467A, light source 337B corresponds to predefined tilted platform 467B, light source 337C corresponds to predefined tilted platform 467C, light source 337D corresponds to predefined tilted platform 467D, and light source 337E corresponds to predefined tilted platform 467E. An increased line-weight is used in FIG. 4 to show where the predefined tilted platform is positioned, although each predefined tilted platform may just be a particular location in the surface shape 460. A transparent encapsulation layer 422 is shown as included in illumination layer 430. Transparent encapsulation layer 422 encapsulates light sources 337. A lens curvature 321 on the eyeward side 109 of the transparent encapsulation layer 422 may be formed in transparent encapsulation layer 422. Lens curvature 221 may be spherical. Transparent encapsulation layer 422 may have a same or substantially same refractive index as transparent substrate 423.

In one implementation, surface shape 460 is rotationally symmetric about an axis in the middle of transparent substrate 423 between an outside boundary of transparent substrate 423. Outside boundaries 431A and 431B are shown at the outside boundaries of transparent substrate 423 and transparent encapsulation layer 422.

FIG. 4 shows that a tilt angle of a given predefined tilted platform 367 may increase as the given predefined tilted platform gets nearer to the outside boundary of the transparent substrate 423. For example, the tilt angle of platform 467C may be substantially zero degrees with respect to a planar boundary 435 of transparent substrate 423 while the tilt angle of platforms 467B and 467D may be approximately five degrees with respect to the planar boundary 435. The tilt angle of platform 467E may be approximately fifteen degrees with respect to planar boundary 435. Thus, the tilt angle of platform 467D may be greater than the tilt angle of platform 467C and the tilt angle of platform 467E may be greater than the tilt angle of platform 467D. Similarly, the tilt angle of platform 467A may be greater than the tilt angle of platform 467B which may be greater than the tilt angle of platform 467C. A beam direction of illumination light 339 emitted by each light source 337 is determined by the tilt angle of the corresponding platform 467.

In FIG. 4, a given predefined tilted platform 467 is positioned closer to eyeward side 108 as a distance of the given predefined tilted platform 467 from the outside boundary of the transparent substrate decreases. For example, predefined tilted platform 467E is positioned closer to eyeward side 109 than predefined tilted platform 467D and the distance from outside boundary 431B to predefined tilted platform 467E is shorter than a distance from predefined tilted platform 467D to outside boundary 431B. Similarly, predefined tilted platform 467B is positioned closer to eyeward side 109 than predefined tilted platform 467C and the distance from outside boundary 431A to predefined tilted platform 467B is shorter than a distance from predefined tilted platform 467C to outside boundary 431A.

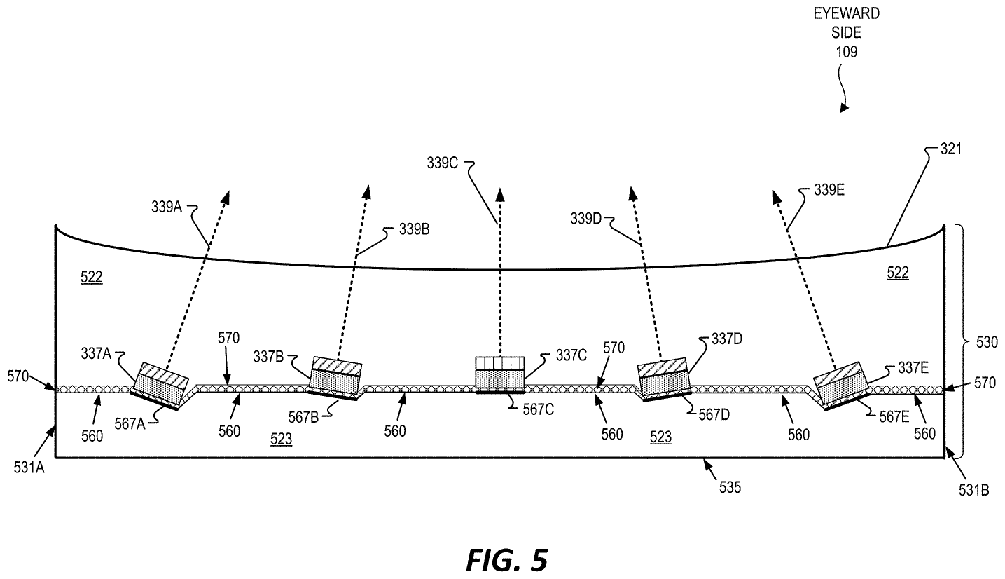

FIG. 5 illustrates a cross-section of an example illumination layer 530, in accordance with aspects of the disclosure. For illumination layers 330 and 430, surface shape 360 and 460 rise as they get closer to the outside edge of the illumination layer. In the implementation illustrated in FIG. 5, surface shape 560 is more planar and includes predefined tilted platforms 567. At least a portion of (e.g. the top) each of the predefined tilted platforms 567 is disposed on a common plane, in the illustrated implementation.

Illumination layer 530 includes an illumination film layer 570 disposed between transparent substrate 523 and transparent encapsulation layer 522. Illumination film layer 570 may be transparent or substantially transparent to visible light, and near infrared light. Illumination film layer 570 may include electrical traces configured to provide electrical power to the plurality of light sources 337. The electrical nodes (e.g. anode node and cathode node) of light sources 337 are bonded to the electrical traces of illumination film layer 570. The electrical traces may be made from a transparent or semi-transparent oxide that is a conductor or semiconductor. In one implementation, the electrical traces include indium tin oxide (ITO). The electrical traces may be copper, gold, or other conducting metal. In FIG. 5, illumination film layer 570 is layered over transparent substrate 523.

In FIG. 5, each predefined tilted platform has a one-to-one correspondence with a corresponding non-visible light source 337. For example, light source 337A corresponds to predefined tilted platform 567A, light source 337B corresponds to predefined tilted platform 567B, light source 337C corresponds to predefined tilted platform 567C, light source 337D corresponds to predefined tilted platform 567D, and light source 337E corresponds to predefined tilted platform 567E. An increased line-weight is used in FIG. 5 to show where the predefined tilted platform is positioned, although each predefined tilted platform may just be a particular location in the surface shape 560. A transparent encapsulation layer 522 is shown as included in illumination layer 530. Transparent encapsulation layer 522 encapsulates light sources 337. A lens curvature 321 on the eyeward side 109 of the transparent encapsulation layer 522 may be formed in transparent encapsulation layer 522. Transparent encapsulation layer 522 may have a same or substantially same refractive index as transparent substrate 523.

In one implementation, surface shape 560 is rotationally symmetric about an axis in the middle of transparent substrate 523 between an outside boundary of transparent substrate 523. Outside boundaries 531A and 531B are shown at the outside boundaries of transparent substrate 523 and transparent encapsulation layer 522.

FIG. 5 shows that a tilt angle of a given predefined tilted platform 367 may increase as the given predefined tilted platform gets nearer to the outside boundary of the transparent substrate 523. For example, the tilt angle of platform 567C may be substantially zero degrees with respect to a planar boundary 535 of transparent substrate 523 while the tilt angle of platforms 567B and 567D may be approximately five degrees with respect to the planar boundary 535. The tilt angle of platform 567E may be approximately fifteen degrees with respect to planar boundary 535. Thus, the tilt angle of platform 567D may be greater than the tilt angle of platform 567C and the tilt angle of platform 567E may be greater than the tilt angle of platform 567D. Similarly, the tilt angle of platform 567A may be greater than the tilt angle of platform 567B which may be greater than the tilt angle of platform 567C. A beam direction of illumination light 339 emitted by each light source 337 is determined by the tilt angle of the corresponding platform 567.

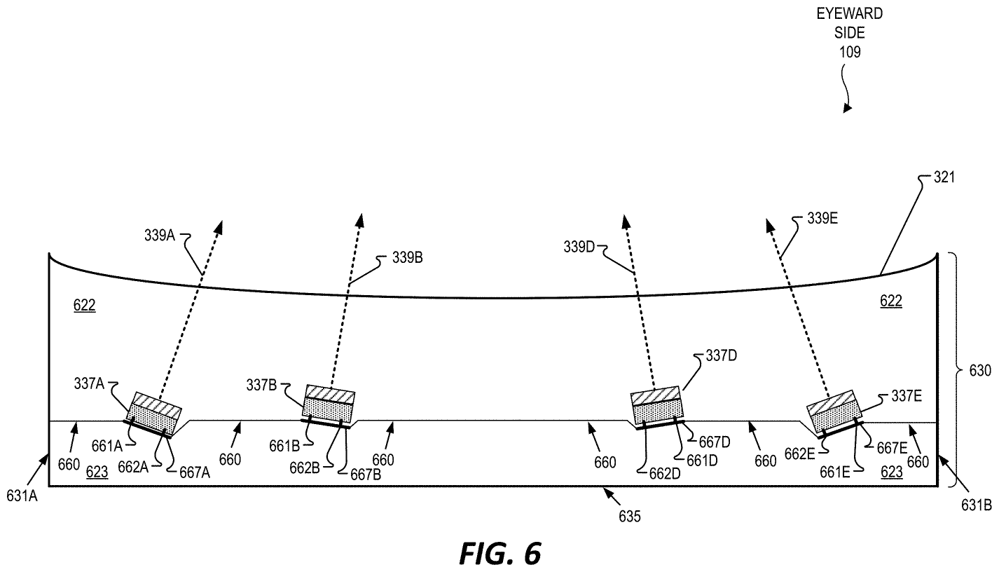

FIG. 6 illustrates a cross-section of an example illumination layer 630, in accordance with aspects of the disclosure. The implementation illustrated in FIG. 6 may have a surface shape 660 that is the same as surface shape 560 where at least a portion of (e.g. the top) each of the predefined tilted platforms 667 is disposed on a common plane. Example illumination layer 630 differs from illumination layer 530 in that illumination layer 630 does not have an illumination film layer 570. Rather, light sources 337 are bonded (e.g. electrically coupled by solder) to electrical traces 661 and 662 that are patterned onto predefined tilted platforms 667 of transparent substrate 623.

In FIG. 6, each predefined tilted platform has a one-to-one correspondence with a corresponding non-visible light source 337. For example, light source 337A corresponds to predefined tilted platform 667A, light source 337B corresponds to predefined tilted platform 667B, light source 337C corresponds to predefined tilted platform 667C, light source 337D corresponds to predefined tilted platform 667D, and light source 337E corresponds to predefined tilted platform 667E. An increased line-weight is used in FIG. 6 to show where the predefined tilted platform is positioned, although each predefined tilted platform may just be a particular location in the surface shape 660. A transparent encapsulation layer 622 is shown as included in illumination layer 630. Transparent encapsulation layer 622 encapsulates light sources 337. A lens curvature 321 on the eyeward side 109 of the transparent encapsulation layer 622 may be formed in transparent encapsulation layer 622. Transparent encapsulation layer 622 may have a same or substantially same refractive index as transparent substrate 623.

In one implementation, surface shape 660 is rotationally symmetric about an axis in the middle of transparent substrate 623 between an outside boundary of transparent substrate 623. Outside boundaries 631A and 631B are shown at the outside boundaries of transparent substrate 623 and transparent encapsulation layer 622.

FIG. 6 shows that a tilt angle of a given predefined tilted platform 367 may increase as the given predefined tilted platform gets nearer to the outside boundary of the transparent substrate 623. For example, the tilt angle of platform 667C may be substantially zero degrees with respect to a planar boundary 635 of transparent substrate 622 while the tilt angle of platforms 667B and 667D may be approximately five degrees with respect to the planar boundary 635. The tilt angle of platform 667E may be approximately fifteen degrees with respect to planar boundary 635. Thus, the tilt angle of platform 667D may be greater than the tilt angle of platform 667C and the tilt angle of platform 667E may be greater than the tilt angle of platform 667D. Similarly, the tilt angle of platform 667A may be greater than the tilt angle of platform 667B which may be greater than the tilt angle of platform 667C. A beam direction of illumination light 339 emitted by each light source 337 is determined by the tilt angle of the corresponding platform 667.

In each illumination layer 330, 430, 530, and 630, the predefined tilted platforms are integrated into the respective transparent substrates 323, 423, 523, and 623. Similarly, in each illumination layer 330, 430, 530, and 630, the non-visible light sources 337 are disposed over the predefined tilted platforms 367/467/567/667 and the predefined tilted platforms 367/467/567/667 are angled to direct the plurality of light sources 337 to illuminate ocular region 207. In FIGS. 3 and 6, light sources 337 may contact the predefined tilted platforms 367/667. In FIGS. 4 and 5, illumination film layer 470 and 570 form an intervening layer between light source 337 and the respective predefined tilted platforms, although the angle of the predefined tilted platforms still defines the orientation of light source 337 and the corresponding beam direction of the illumination light 339.

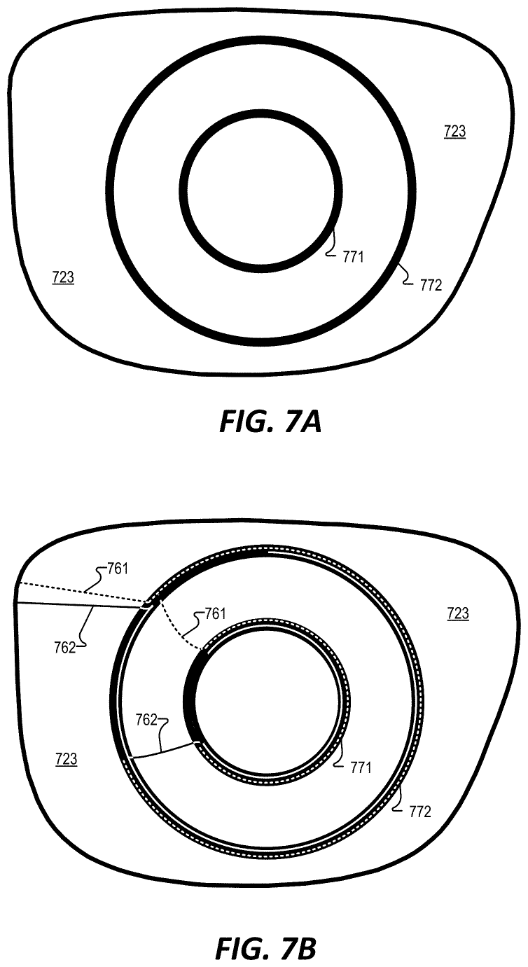

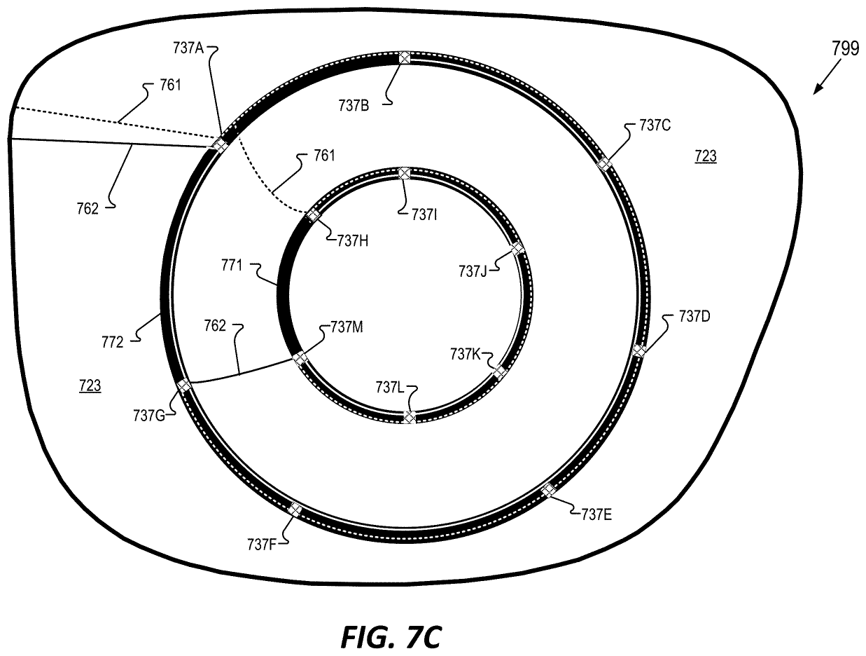

FIGS. 7A-7C illustrate portions of an example illumination layer fabrication technique, in accordance with aspects of the disclosure. The fabrication technique illustrated in FIGS. 7A-7C may be utilized to fabricate illumination layer 630, for example. In FIG. 7A, grooves 771 and 772 are formed in a transparent substrate 723. Transparent substrate 723 may be glass, sapphire, thick transparent polymers, or other transparent material. Grooves 771 and 772 may be formed by way of casting, molding, or three-dimensional (3D) printing. Grooves 771 and 772 may also be formed in transparent substrate 723 in a subtractive process such as diamond turning. In an implementation, groove 771 is shaped as a circle having a diameter of approximately 25 mm. Groove 771 may be less than 500 microns wide and less than 200 microns deep, in some implementations. In an implementation, groove 772 is shaped as a circle having a diameter of approximately 36 mm. Groove 772 may be less than 500 microns wide and less than 200 microns deep, in some implementations. Groove 771 may be angled similarly to predefined tilted platform 667B and 667D and groove 772 may be angled similarly to predefined tilted platform 667A and 667E. In this way, predefined tilted platforms having the same mechanical tilt angle as grooves 771 and 772 provide mechanical tilting for light sources 737. Grooves 771 and 772 may be angled so that each light source is tilted so that a beam direction of non-visible illumination light is directed inwardly.

FIG. 7B illustrates electrical traces 761 and 762 that are patterned onto the grooves 771 and 772 and transparent substrate 723. Electrical traces 762 are shown as a continuous line and electrical traces 761 are illustrated as a dashed line for illustration purposes although those skilled in the art appreciate that electrical trace 761 will be continuous in actual implementation to provide electrical power. Electrical traces 761 may be a voltage supply and electrical traces 762 may be a ground rail. The electrical traces 761 may bring electrical power from the edge of transparent substrate 723 from frame 102, for example. Additional electrical traces may be patterned onto transparent substrate 723 and in grooves 771 and 772. In an example (not illustrated), additional electrical traces provide more selective control for illuminating light sources on an individual basis.

FIG. 7C illustrates that light sources 737 have been electrically coupled to traces 761 and 762 for providing electrical power to light sources 737. The illustrated implementation includes light sources 737A-737M where light sources 737A-373G are disposed along groove 772 and light sources 737H-737-M are disposed along groove 771. In other implementations, more or fewer light sources may be used and different patterns may be used. An encapsulation layer (not illustrated) such as encapsulation layer 622 may be formed over optical element 799 of FIG. 7C to fabricate illumination layer 630. A resin may be used in a molding process to form encapsulation layer 622 over optical element 799, for example.

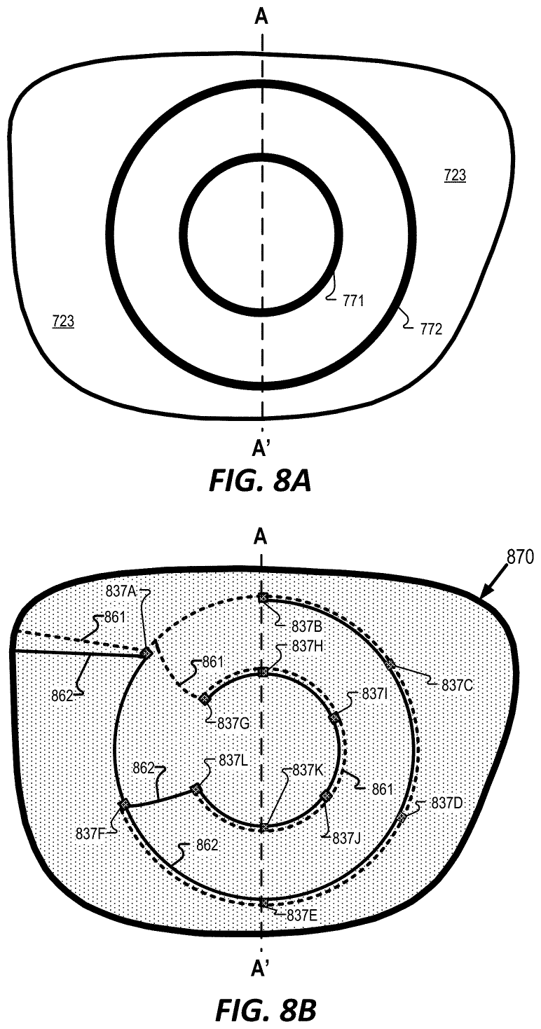

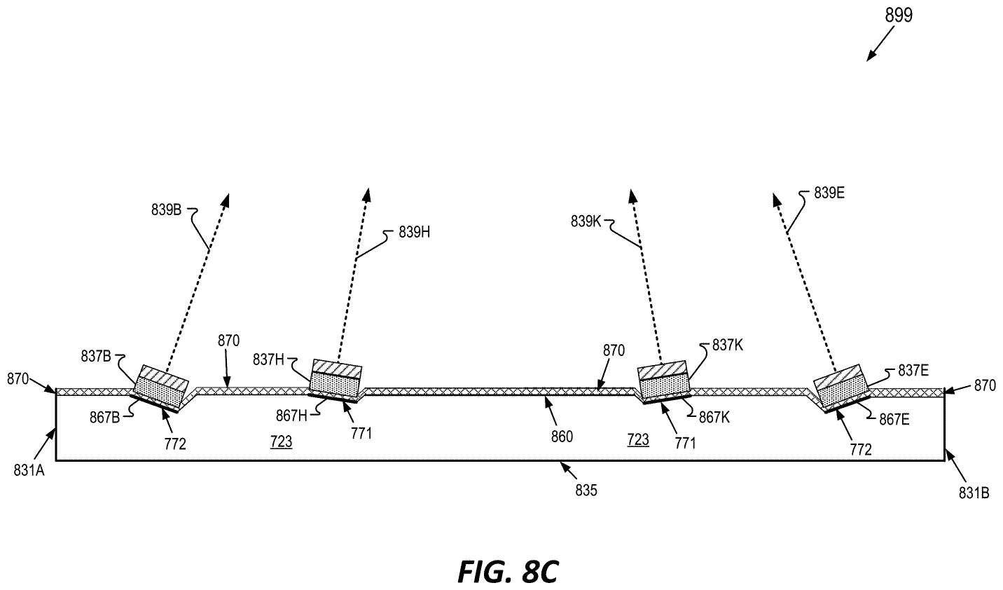

FIGS. 8A-8C illustrate a fabrication technique for an illumination layer having an illumination film layer, in accordance with aspects of the disclosure. The fabrication technique illustrated in FIGS. 8A-8C may be utilized to fabricate an illumination layer similar to illumination layer 530 (without light source 337C), for example. In FIG. 8A, grooves 771 and 772 are formed in a transparent substrate 723. Groove 771 may be angled similarly to predefined tilted platform 567B and 567D and groove 772 may be angled similarly to predefined tilted platforms 567A and 567E.

FIG. 8B illustrates an example illumination film layer 870 that includes light sources 837A-837L. Illumination film layer 870 also includes electrical traces 861 and 862 to provide electrical power to the light sources 837. The light sources 837 are bonded (e.g. soldered) to the electrical traces. Electrical traces 862 are shown as a continuous line and electrical traces 861 are illustrated as a dashed line for illustration purposes although those skilled in the art appreciate that electrical trace 861 will be continuous in actual implementation to provide electrical power. Electrical traces 861 may be a voltage supply and electrical traces 862 may be a ground rail. The electrical traces 861 may bring electrical power from the edge of transparent substrate 723 from frame 102, for example. Additional electrical traces may be patterned onto illumination film layer 870. In an example (not illustrated), additional electrical traces provide more selective control for illuminating light sources on an individual basis.

In FIG. 8C, illumination film layer 870 has been layered over transparent substrate 723 to form optical element 899. FIG. 8C illustrates a side view of a cross-section of transparent substrate 723 and illumination film layer 870 through a plane A-A′ in FIGS. 8A and 8B. Light sources 837H and 837K are layered over groove 771 and light sources 837B and 837H are layered over groove 772, in FIG. 8C. Platform 867H and platform 867K show the portion of grove 771 that light sources 837H and 837K are disposed over, respectively. In other words, predefined tilted platform 867H and predefined tilted platform 867K are defined by the angle of groove 771. Thus light sources 837H and 837K are angled according to the angle of groove 771. Similarly, predefined tilted platform 867B and predefined tilted platform 867E are defined by the angle of groove 772 so light sources 837H and 837K are angled according to the angle of groove 772. Platform 867B and platform 867E show the portion of grove 772 that light sources 837B and 837E are disposed over, respectively.

Illumination film layer 870 may be bonded to transparent substrate 723 with an optically transparent adhesive. In some implementations, illumination film layer 870 is malleable such that vacuum pressure is sufficient to conform illumination film layer 870 to the contours of surface shape 860 (including grooves 771 and 772 and predefined tilted platforms 867). In this way, the light sources 837 are properly positioned and angled according to the mechanical tilt provided by grooves 771 and 772.

An encapsulation layer (not illustrated) such as encapsulation layer 522 may be formed over optical element 899 of FIG. 8C to fabricate illumination layer 530. A resin may be used in a molding process to form transparent encapsulation layer 522 over optical element 899, for example.

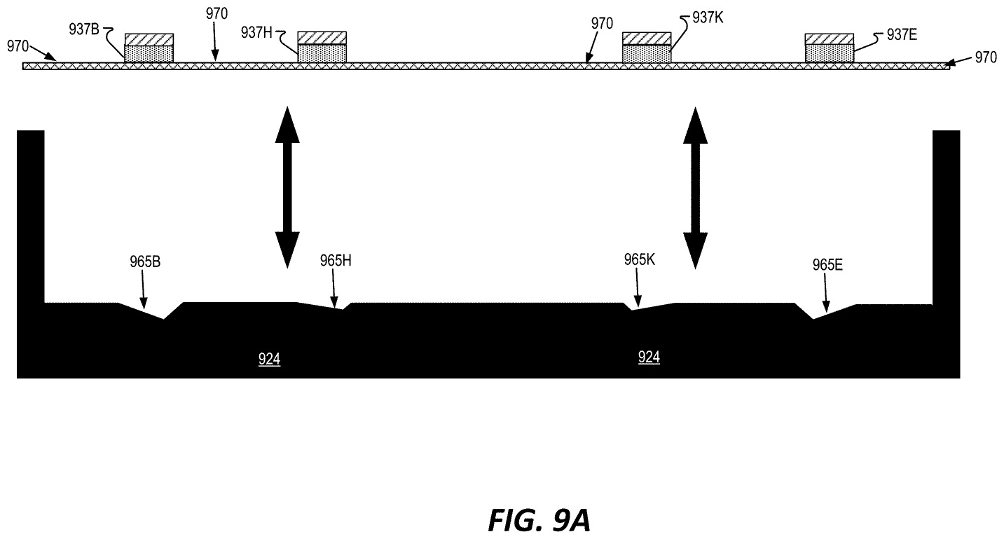

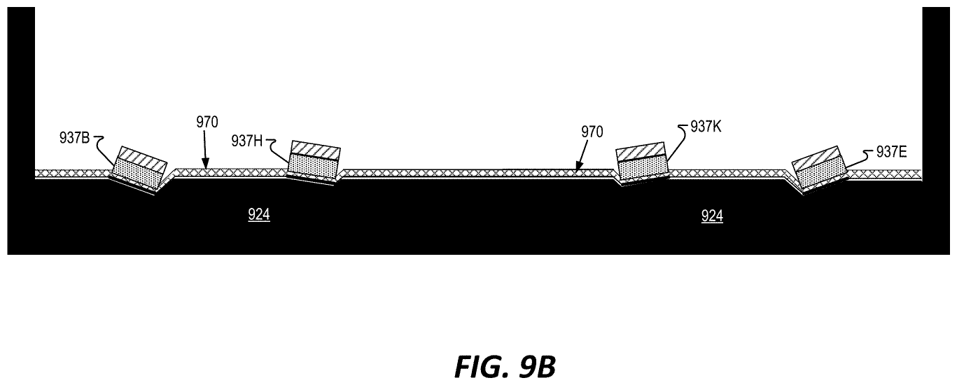

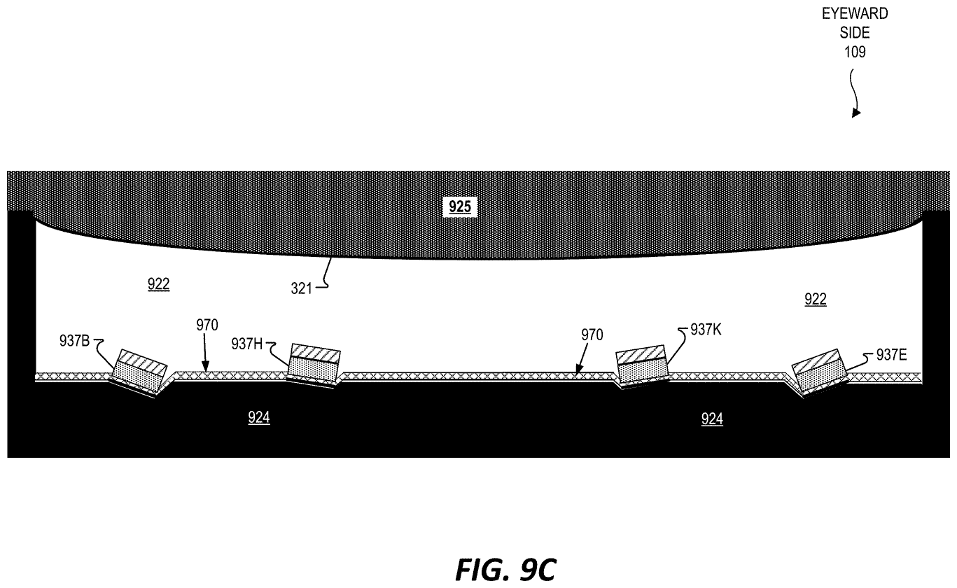

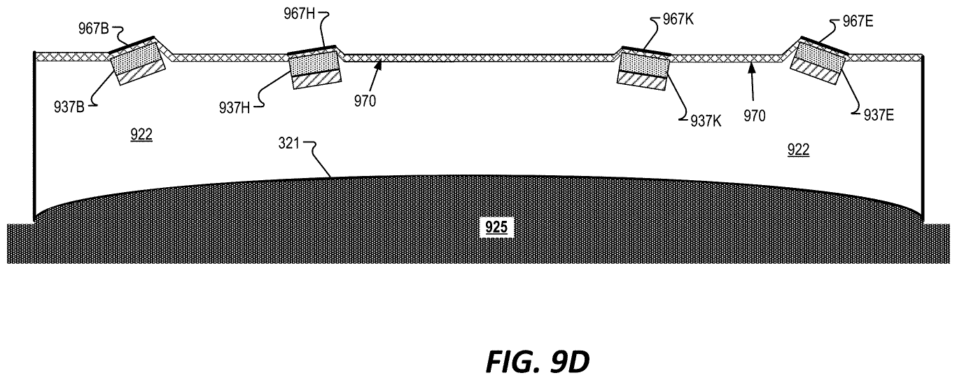

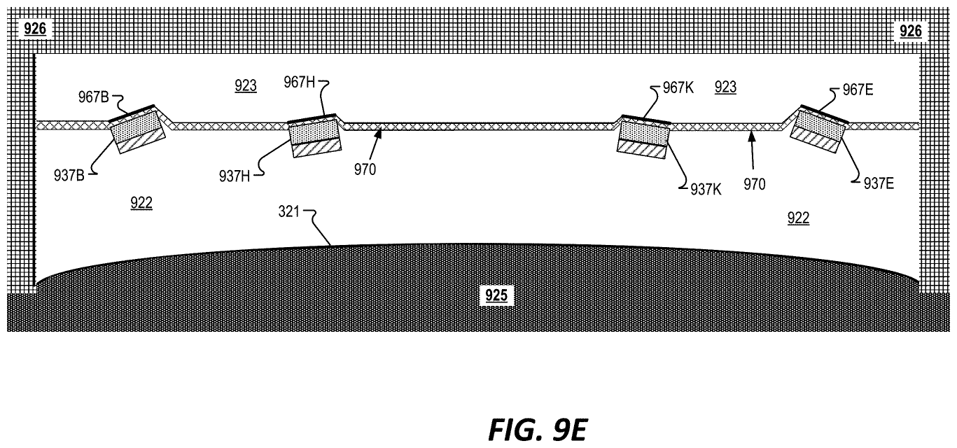

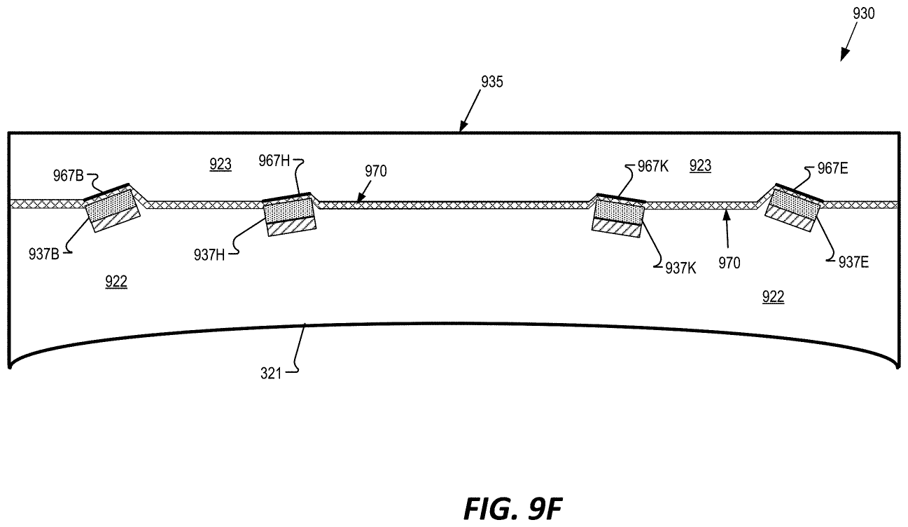

FIGS. 9A-9F illustrate an example fabrication process for an illumination layer, in accordance with aspects of the disclosure. FIG. 9A illustrates providing an illumination film layer 970 and a first mechanical fixture 924. First mechanical feature 924 may be made of metal. Mechanical fixture 924 is configured to define tilted platforms 967 (illustrated in FIG. 9D) by way of mechanical features 965. Mechanical feature 965B will define tilted platform 967B, mechanical feature 965H will defined tilted platform 967H, mechanical feature 965K will defined tilted platform 967K, and mechanical feature 965E will defined tilted platform 967E.

In FIG. 9B, illumination film layer 970 is positioned over mechanical fixture 924. Illumination film layer 970 may be malleable such that vacuum pressure is sufficient to conform illumination film layer 970 to the contours of mechanical fixture 924 (including mechanical features 965).

In FIG. 9C, a transparent optical resin 922 is formed over the illumination film layer 970. Casting, molding, or insert-molding techniques may be used to form transparent optical resin 922 over illumination film layer 970. In the illustrated implementation, a second mechanical fixture 925 is provided to form lens curvature 321 on an eyeward side 109 of the transparent optical resin 922 that is opposite illumination film layer 970.

The transparent optical resin 922 is cured while illumination film layer 970 is disposed over mechanical fixture 924 and light sources 937 are disposed over their corresponding mechanical features 965 that define tilted platforms 967.

FIG. 9D shows the first mechanical fixture 924 has been removed after the transparent optical resin 922 is cured. Notably, light sources 937 are cured into place and take on the mechanical tilt or orientation of mechanical features 965 that are configured to define the tilted platforms 967 that are angled to direct the plurality of non-visible light sources to illuminate an ocular region with non-visible light.

FIG. 9E illustrates a third mechanical fixture 926 has been coupled to the second mechanical fixture 925 so that optical layer 923 can be over-molded onto the illumination film layer 970. Optical layer 923 may be formed with an optically transparent resin. Optical layer 923 may have a same refractive index as cured transparent optical resin 922.

FIG. 9F illustrates illumination layer 930 after it is removed from the second mechanical fixture 925 and the second mechanical fixture 925. Illumination layer 930 may have a planar boundary 935 to assist coupling illumination layer 930 with another optical component such as combiner layer 240. Planar boundaries 335, 435, 535, 635, and 835 may be planar for similar purposes. Mechanical fixtures 924, 925, and 926 may be configured for compression molding or injection molding techniques. Illumination layer 930 may include the attributes of illumination layer 530. Those skilled in the art appreciate that the fabrication technique described with respect to FIGS. 9A-9F may also be adapted to fabricate similar illumination layers such as illumination layer 430.

A variety of fabrication techniques may be employed to fabricate illumination layers of this disclosure. In some implementations of the disclosure, 3D printing techniques may be used to fabricate all or portions of the disclosed illumination layers. In some implementations, a stamping or transfer molding of optical resins on a transparent polymer film is used to generate predefined tilted platforms. The transparent polymer film may be disposed on a roll and a dispensing unit may dispense the optical resin onto the optically transparent material prior to a patterned stamp stamping the resin to form the predefined tilted platforms while ultraviolet light cures the predefined tilted platforms into place after the stamping.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some implementations, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The above description of illustrated implementations of the invention, including what is described in the Abstract, is not intended to be exhaustive or to limit the invention to the precise forms disclosed. While specific implementations of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific implementations disclosed in the specification. Rather, the scope of the invention is to be determined entirely by the following claims, which are to be construed in accordance with established doctrines of claim interpretation.

What is claimed is:

1. A near-eye optical element including:
a transparent substrate having predefined tilted platforms integrated into the transparent substrate; and
a plurality of light sources disposed over the predefined tilted platforms, wherein the predefined tilted platforms are angled to direct the plurality of light sources to illuminate an ocular region.

2. The near-eye optical element of claim 1, wherein a tilt angle of a given predefined tilted platform increases as the given predefined tilted platform gets nearer to an outside boundary of the transparent substrate.

3. The near-eye optical element of claim 1, wherein a beam direction of a given light source in the plurality of light sources is determined by a tilt angle of a corresponding predefined tilted platform that the light sources are disposed over.

4. The near-eye optical element of claim 1, further comprising an illumination film layer including electrical traces configured to provide electrical power to the plurality of light sources, wherein the illumination film layer has the plurality of light sources bonded to the electrical traces, and wherein the illumination film layer is layered over the transparent substrate.

5. The near-eye optical element of claim 1, wherein the light sources are in-field light sources positioned to be in a field-of-view (FOV) of a user that is using the near-eye optical element.

6. The near-eye optical element of claim 1 further comprising:
a transparent encapsulation layer encapsulating the predefined tilted platforms and the plurality of light sources.

7. The near-eye optical element of claim 6, wherein the transparent encapsulation layer has a substantially same refractive index as the transparent substrate.

8. The near-eye optical element of claim 6, wherein the transparent encapsulation layer includes a lens curvature on an eyeward side of the transparent encapsulation layer.

9. The near-eye optical element of claim 1, wherein each light source in the plurality of light sources is configured to emit narrow-band non-visible light.

10. The near-eye optical element of claim 9, wherein the light sources include a vertical-cavity surface-emitting laser (VCSEL).

11. The near-eye optical element of claim 1 further comprising:
a combiner layer configured to receive reflected near-infrared light emitted by the light sources that reflects off the ocular region and direct the reflected near-infrared light to a camera.

12. The near-eye optical element of claim 1, wherein a given predefined tilted platform is positioned closer to an eyeward side of the near-eye optical element as a distance of the given predefined tilted platform from an outside boundary of the transparent substrate decreases.

13. The near-eye optical element of claim 12, at least a portion of each of the predefined tilted platforms is disposed on a common plane.

14. A method of fabricating a near-eye optical element comprising:
providing an illumination film layer that includes a plurality of non-visible light sources coupled to electrical traces providing electrical power to the plurality of non-visible light sources;
positioning the illumination film layer over a mechanical fixture configured to define tilted platforms angled to direct the plurality of non-visible light sources to illuminate an ocular region with non-visible light emitted by the non-visible light sources, wherein each non-visible light source in the plurality of non-visible light source has a corresponding tilted platform;
disposing a transparent optical resin over the illumination film layer while the illumination film layer is positioned over the tilted platform; and
curing the transparent optical resin while the illumination film layer is positioned over the mechanical fixture.

15. The method of claim 14 further comprising:
forming a lens curvature on an eyeward side of the transparent optical resin that is opposite the illumination film layer.

16. The method of claim 14 further comprising:
removing the mechanical fixture from the illumination film layer after the transparent optical resin is cured; and
forming an optical layer, wherein the illumination film layer is between the optical layer and the cured transparent optical resin.

17. The method of claim 16, wherein the optical layer and the cured transparent optical resin have a same refractive index.

18. The method of claim 14, wherein the non-visible light sources include a vertical-cavity surface-emitting laser (VCSEL).

19. A near-eye optical system including:
a plurality of light sources encapsulated within a transparent illumination layer, the light sources being encapsulated within the transparent illumination layer at different angles to direct the plurality of light sources inward to illuminate an ocular region;
a camera; and
a combiner layer configured to direct reflections of non-visible light reflecting from the ocular region to the camera, wherein the non-visible light is emitted by the plurality of light sources, and wherein the camera is configured to image a wavelength range that includes the non-visible light while blocking light wavelengths outside the wavelength range.

20. The near-eye optical system of claim 19, wherein the reflections of the non-visible light encounter the transparent illumination layer prior to encountering the combiner layer.
